(19) United States
(12) Patent Application Publication
(10) Pub. No.: US 2009/0032204 A1
(43) Pub. Date: Feb. 5, 2009

(54) Corridor flange

(76) Inventors: Kevin J. Mintie, Glendale, CA (US); Jose Guadalupe Munoz, Valinda, CA (US)

Correspondence Address: CHRISTIE, PARKER & HALE, LLP, PO BOX 7068, PASADENA, CA, 91109-7068, US

(21) Appl. No.: 12/217,451

(22) Filed: Jul. 2, 2008

Related U.S. Application Data
(60) Provisional application No. 60/963,085, filed on Aug. 1, 2007.
(60) Provisional application No. 60/963,216, filed on Aug. 2, 2007.

(51) Int. Cl. E06B 9/00

(52) U.S. Cl. 160/184; 160/354

(57) ABSTRACT

The present invention provides a flange that can be used independently or in combination with an environmental containment unit for isolating a large area of a building and to a method of using the same. The corridor flange is installed in a corridor of the building to isolate one side of the building on one side of the flange from another side of the building on the other side of the flange.

### CROSS-REFERENCE TO RELATED APPLICATIONS

This application is based upon and claims priority and is based upon U.S. Provisional Patent Application No. 60/963,085, filed on Aug. 1, 2007 and on U.S. Provisional Patent Application No. 60/963,216, filed on Aug. 2, 2007, the contents of both of which are hereby fully incorporated herein by reference.

### BACKGROUND OF THE INVENTION

The present invention relates to a flange used as part of an isolation system, and to a method, for isolating an area of a building or a corridor by using any location in a corridor for providing an area of isolation. Many times it is important in buildings as for example high profile office buildings, government facilities, airports, hospitals etc. to separate one area from another. For example it may be necessary to isolate a large area in a hospital for isolating a multitude of patients in a wing of the hospital. Current methods for such isolation are time consuming, requiring a barrier fabrication for the closing off of areas. A better system and method is desired that allows for the easy and timely isolation of a large area in a building.

### SUMMARY OF THE INVENTION

A corridor flange for isolating a section of a corridor is provided. The flange includes a sealable opening allowing for penetration of the flange, a top edge, a bottom edge, a first side edge extending between the top and bottom edges, a second side opposite the first side edge and extending between the top and bottom edges, a first strip of Velcro along the top edge, a second strip of Velcro along the bottom edge, a third strip of Velcro along the first side edge, a fourth strip of Velcro along the second side edge, a first flap coupled to the flange and extending over the first strip, a second flap coupled to the flange and extending over the second strip, a third flap coupled to the flange and extending over the third strip, and a fourth flap coupled to the flange and extending over the fourth strip.

In another exemplary embodiment, a flange for isolating a section of a corridor is provided. The flange includes a body including a first surface opposite a second surface, a re-closeable opening formed through the body allowing for penetration through the flange, a first edge, a second edge opposite the first edge, a third edge extending between the first and second edges, a fourth edge opposite the third edge and extending between the first and second edges, a first fastener adjacent the first edge, a second fastener adjacent the second edge, a third fastener adjacent the third edge, a fourth fastener adjacent the fourth edge, a first flap coupled to the flange first surface and extending over the first fastener, a second flap coupled to the flange first surface and extending over the second fastener, a third flap coupled to the flange first surface and extending over the third fastener, and a fourth flap coupled to the flange first surface and extending over the fourth fastener.

In another exemplary embodiment, an opening is formed through the flange for accommodating a vacuum source. In yet another exemplary embodiment, the flange also includes an opening for accommodating a conduit coupled to a HEPA filtered air machine. In a further exemplary embodiment, a zipper is coupled to the flange and surrounds at least part of the opening for coupling via zippering with an environmental containment unit. In yet a further exemplary embodiment, the zipper is for zippering the flange around an opening in the environmental containment unit. In another exemplary embodiment means are provided coupled to the flange and surrounding at least part of the opening for coupling with an environmental containment unit. In yet another exemplary embodiment, the flange includes a section extending to the first edge. The section includes a folded portion extending from the third edge to the fourth edge. The flange may also include means for retaining the folded portion in a location over the opening. The flange may also include a string coupled to the section of the flange, a strip attached to the flange such that the string is sandwiched between the strip and the flange, and a member slideable along the string for pushing the flange along the string. In another exemplary embodiment the flange further includes a fifth flap coupled to the flange second surface, such that the first fastener is located between the first and fifth flaps, a sixth flap coupled to the flange second surface, such that the second fastener is located between said second and sixth flaps, a seventh flap coupled to the flange second surface, such that the third fastener is located between said third and seventh flaps, and an eighth flap coupled to the flange second surface, such that the fourth fastener is located between said fourth and eighth flaps. The flange may also include a fifth fastener adjacent the first fastener, a sixth fastener adjacent the first fastener for fastening with the fifth fastener, a seventh fastener adjacent the second fastener, and an eighth fastener adjacent the second fastener for fastening with the seventh fastener. The flange may also include a ninth fastener adjacent the third fastener, a tenth fastener adjacent the third fastener for fastening with the ninth fastener, an eleventh fastener adjacent the fourth fastener, and a twelfth fastener adjacent the fourth fastener for fastening with the eleventh fastener. In another exemplary embodiment, the flange also includes a first panel, a second panel extending from the first panel, a third panel extending from the first panel opposite the second panel, a fourth panel extending from the first panel and adjacent the second and third panels, and a fifth panel extending from the first panel opposite the fourth panel and adjacent the second and third panels, wherein the first fastener is mounted over the second panel, the second fastener is mounted over the third panel, the third fastener is mounted over the fourth panel, and the fourth fastener is mounted over the fifth panel. In yet another exemplary embodiment, the opening is formed through the first panel.

In a further exemplary embodiment a flange for isolating a section of a corridor is provided including a body including a first surface opposite a second surface, a re-closeable opening formed through the body allowing for penetration through the flange, a first edge, a second edge opposite the first edge, a third edge extending between the first and second edges, a fourth edge opposite the third edge and extending between the first and second edges, a first flap coupled to the flange first surface and extending over the first edge, a second flap coupled to the flange first surface and extending over the second edge, a third flap coupled to the flange first surface and extending over the third edge, and a fourth flap coupled to the flange first surface and extending over the fourth edge. The flange may also include a fifth flap coupled to the flange second surface such that the first edge is located between the first and fifth flaps, a sixth flap coupled to the flange second surface, such that the second edge is located between the second and sixth flaps, a seventh flap coupled to the flange second surface, such that the third edge is located between the third and seventh flaps, and an eighth flap coupled to the flange second surface, such that the fourth edge is located between the fourth and eighth flaps.

In yet a further exemplary embodiment a flange for isolating a section of a corridor is provided including a body including a first surface opposite a second surface, a re-closeable opening formed through the body allowing for penetration through the flange, a first edge, a second edge opposite the first edge, a third edge extending between the first and second edges, a fourth edge opposite the third edge and extending between the first and second edges, a fastener over the first surface adjacent one of the edges, and a first flap coupled to the flange first surface and extending over the fastener. In another exemplary embodiment, the flange may also include a second flap coupled to the second surface such that the fastener is located between the first and second flaps.

In yet another exemplary embodiment, a flange for isolating a section of a corridor is provided including a body including a first surface opposite a second surface, a re-closeable opening formed through the body allowing for penetration through the flange, a perimetral edge surrounding the body, a fastener along the perimetral edge, and a first flap coupled to the flange first surface extending over the fastener. In a further exemplary embodiment, the flange may also include a second flap coupled to the second surface such that the fastener is located between the first and second flaps.

In any of the aforementioned exemplary embodiments, each fastener may be a strip of Velcro, an adhesive, a strip of adhesive or any other type of fastener.

### BRIEF DESCRIPTION OF THE DRAWINGS

FIG. 1 is a front schematic view of an exemplary embodiment corridor flange of the present invention.

FIG. 2 is a perspective view of an exemplary corridor flange of the present invention attached to a corridor.

FIGS. 3 and 4 are cross-sectional views of the flaps and corridor flange panel incorporated in the inventive flange shown in FIG. 1 as taken along arrows 3-3 and 4-4 respectively.

FIG. 5 is a partial exploded end view taken at arrow 5-5 in FIG. 2 showing a fold of an exemplary embodiment corridor flange for shortening the length of the corridor flange.

FIGS. 6A and 6B are cross-sectional views showing the attachment of the corridor flange of the present invention around a handrail at a location without a hand rail post and at a location with a hand rail post, respectively.

### DETAILED DESCRIPTION OF THE INVENTION

The present invention provides a flange 10 that can be used independently or in combination with an environmental containment unit for isolating a large area of a building and to a method of using the same. The corridor flange is releasably attached to a corridor of the building to isolate one side of the building on one side of the corridor from another side of the building on the other side of the corridor. The corridor flange in an exemplary embodiment is formed from material that is impermeable to hazardous waste, as for example organic or inorganic airborne particulate matter that may pose an infection or other health risk. The material may be permeable to air or other particulates such as moisture. Exemplary materials include vinyl or plastic sheeting. One exemplary material is 1200 Denier material.

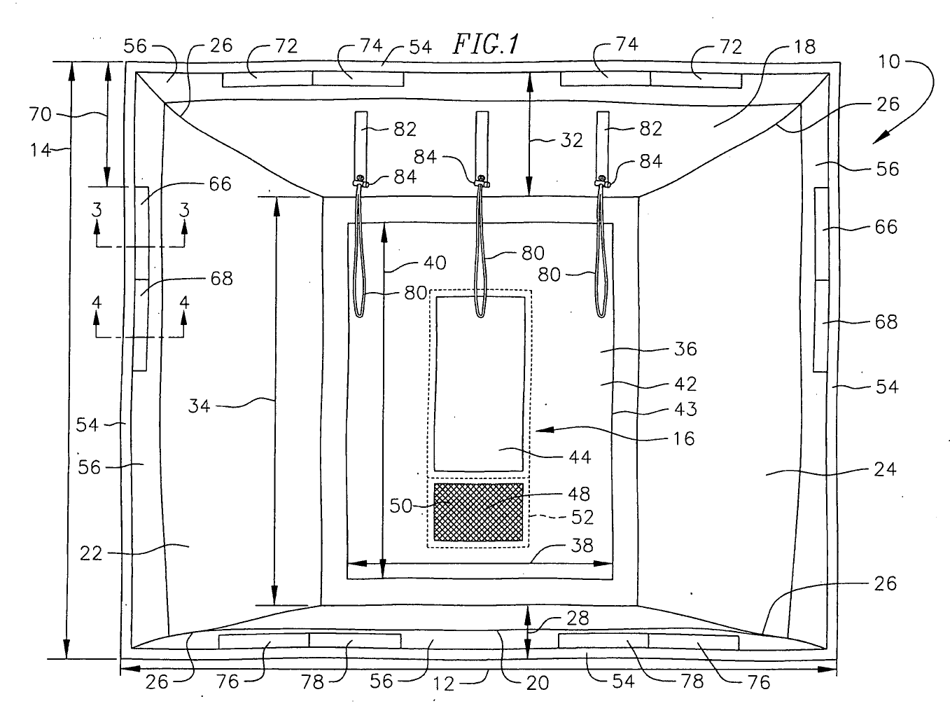

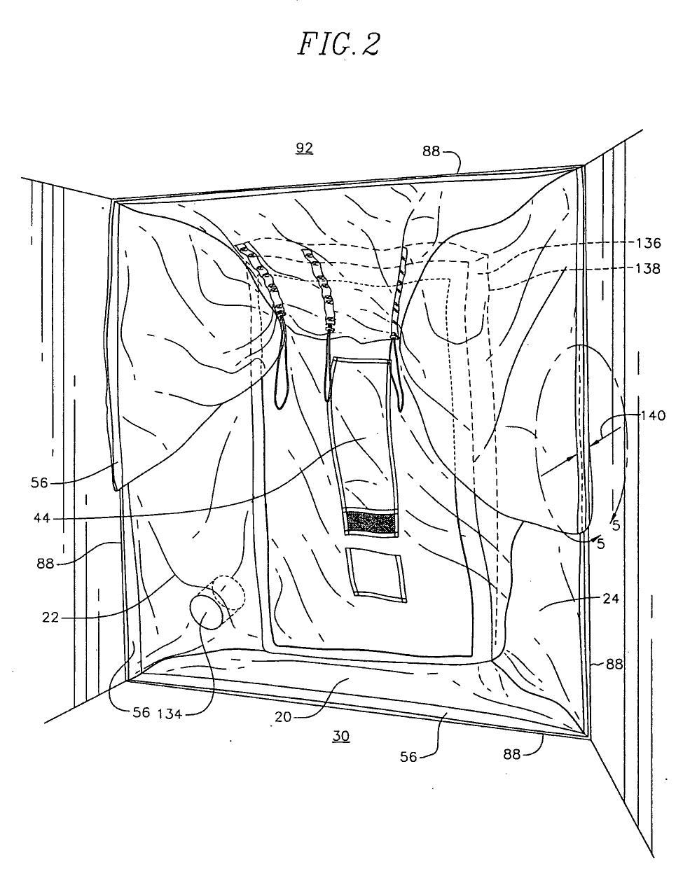

As shown in FIGS. 1 and 2 in an exemplary embodiment, the flange 10 has a width 12 of about 10 feet and a height 14 of about 11 feet high, so as to be useable in most corridors which are typically 8 feet wide by and 8 to 10 feet high. By using a corridor flange which is 10 feet wide by 11 feet high, the corridor flange may be used in various corridors of different width and height dimensions. The corridor flange may also be made to have larger dimensions if it will be used in larger corridors. In other exemplary embodiments, the corridor flange may have dimensions that are similar or the same as those of the corridor to which it will be attached.

In an exemplary embodiment, the corridor flange includes five panels. The five panels include a central panel 16 from which extend a top panel, 18 a bottom panel 20 opposite the top panel 22 and two opposite side panels 22, 24 extending from either side of the central panel 18 and between the top and bottom panels. In the exemplary embodiment, the four panels (also referred to herein for convenience as the “perimetral panels”) which extend around the central panel are each connected to each other along an oblique seam 26. In other exemplary embodiments, each connective seam may be either vertical, horizontal or oblique. In another exemplary embodiment, two or more, or all, of the panels may be integrally formed as a single panel.

In an exemplary embodiment the bottom panel 20 has a height 28 of about 2 feet. When installed the bottom panel lays flat against a corridor floor 30 along its height. Applicants have discovered that 2 feet is a sufficient length for covering the floor. In other exemplary embodiments, the bottom panel may have other height dimensions. The top panel in an exemplary embodiment has a height 32 that is greater than 2 feet. When installed on a corridor in an exemplary embodiment, the central panel 16 extends from the floor upward. In an exemplary embodiment the central panel has a height 34 of about 6 feet and the top panel has a height 32 of about 3 feet.

An opening 36 is formed through the central panel allowing for people to be able to get from one side of the corridor to the other when the corridor flange is installed. An exemplary opening has width 38 of about 4 feet and a height 40 of about 5 feet. The opening is closed by a door panel 42 made typically from the same material as the corridor flange. In an exemplary embodiment, the door panel connects to the central panel for closing the opening with a zipper 43. In another exemplary embodiment, the door panel may connect with the corridor flange with other means as for example Velcro or other types of fasteners. The door panel may have a central transparent portion 44 so that people can look through it before opening the panel. In addition, a flap 46 may extend from one side of the transparent portion to cover the transparent portion for privacy. Velcro or other means may be used to connect the flap in position to cover the transparent portion. In one example, at an end, the flap may be sewn on to the door panel and at another end it may connect to the door panel using Velcro so as to block one's view through the transparent portion. In such case, when the transparent portion needs to be unobstructed, the flap may be rolled to an open position toward the sewn end and tied in place using means such as strings also connected to the door panel.

An air vent 48 may also be provided on the door panel. The air vent may be positioned at any location. In an exemplary embodiment the air vent is positioned below the transparent portion. In an exemplary embodiment, the air vent is an opening formed on the door panel that is covered by a mesh material 50. A removable flap 52 may be positioned behind the air vent so as to close the air vent when circulation is not necessary. In an exemplary embodiment, this flap may connect around an entire perimeter of the vent using Velcro so as to complete seal the vent.

A main strip 54 of Velcro is attached along the free edge of each of the perimetral panels. In an exemplary embodiment, a main strip of Velcro is attached on both sides of each of said panels along the edge of such panel, as for example shown in FIGS. 1, 3 and 4. The main Velcro strip may be any type of Velcro such as a loop-type of Velcro or a hook-type of Velcro. For illustrative purposes, the invention herein is described with using a main strip of loop-type Velcro which will be connect with a hook-type Velcro. In an exemplary embodiment, the main strips of Velcro used along each of the perimetral panels are one inch wide.

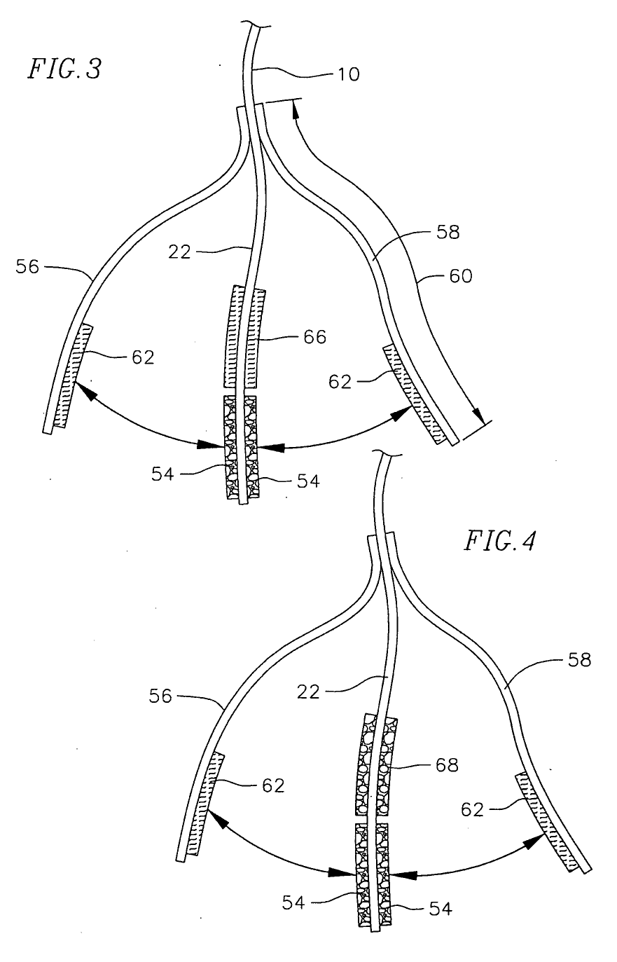

In an exemplary embodiment, a strip of material, which in an exemplary embodiment is the same type of material which forms the panel, is attached proximate the edge of each of the perimetral panels and extends to the free edge of each panel, so as to form a flap 56 (shown in see-through in FIG. 1 and also shown in FIGS. 3 and 4) that covers the main strip Velcro 54 of Velcro attached along such edge. A similar strip of material is attached on the opposite panel surface forming a flap 58 for covering the strip of main Velcro also attached on such opposite panel surface. In an exemplary embodiment each flap has a height 60 of about 4 inches. Small sections or tabs 62 of Velcro are attached on the inner surfaces of the flaps along different locations to allow the flap to connect with the main Velcro strips on the edges of the panel, so as to hold the flap in a position covering the main Velcro strip 54 and thereby protecting the main Velcro strip from exposure to the environmental elements. Since in the exemplary embodiment described herein the main Velcro strips on the perimetral panels are a loop-type of Velcro, the Velcro tabs on the flaps are a hook-type Velcro so as to be able to connect to the hook-type Velcro on the perimetral panels.

In an exemplary embodiment, on the top portions of each of the side panels and on opposite sides of each of the side panels proximate their edge and adjacent the main strip 54 of Velcro is attached a first strip of Velcro 66. A second strip of Velcro 68 is attached immediately below the first strip also adjacent to the main strip. The two strips are opposite types of Velcro such that when the panel is folded onto itself the two strips can connect with each other. In an exemplary embodiment said first strips are attached at a distance 70 of about one foot below the upper edge of the top panel. Furthermore in an exemplary embodiment each of the first and second strips of Velcro is about 2 feet long.

In an exemplary embodiment, two longitudinally aligned strips 72, 74 of opposite type of Velcro are attached adjacent and inward of the main strip on both sides of the top panel proximate a left edge of the top panel and proximate a right edge of the top panel, as for example shown in FIG. 1. Similarly two strips 76, 78 of longitudinally aligned opposite type of Velcro are attached adjacent and inward of the main strip on both sides of the bottom panel proximate a left edge of the bottom panel and proximate a right edge of the bottom panel, as for example shown in FIG. 1. In an exemplary embodiment each of the first and second strips on the top and bottom panels is about one foot in length. The first of each of these strips is positioned so as to be about a foot from their corresponding right or left edge of the top and bottom panels.

In a further exemplary embodiment, at a top portion of the top panel above the opening, are attached one or more strings, ropes or pieces or strips of material (collectively or individually referred to herein as “strings” 80). In an exemplary embodiment, three strings 80 are attached spaced apart with one string generally located around a center between the left and ride sides of the top panel. A strip of fabric 82 is attached to the top panel covering each of the strings. These strips form pouches accommodating the strings. Lock units 84 which are known in the art are positioned at the end of the string. Each of the lock units includes spring-loaded cylindrical members 86 which are penetrated by the string. When the cylindrical members are compressed they are able to slide along the string and when they are released, they lock onto the string.

In an exemplary embodiment, in order to attach the flange to the corridor, a strip of Velcro is attached or otherwise connected to each of the side walls, the ceiling and the floor defining the corridor. In exemplary embodiment each of these Velcro strips extends across the entirety of the wall, ceiling or floor onto which it is attached. For convenience, these strips of Velcro are referred to herein as the “corridor Velcro strips 88.” Since in the exemplary embodiment, the main Velcro strips on the edges of the panels are of the loop-type of Velcro, the corridor Velcro strips are a hook-type of Velcro.

The main Velcro strips 54 are attached to the corresponding corridor Velcro strips 88 such that the edges of the side panels are attached to the walls, the edge of the top panel is attached to the ceiling and the edge of the bottom panel is attached to the floor. In one exemplary embodiment, first the main Velcro strip on the bottom panel is attached on the corridor Velcro strip on the floor. The bottom panel is then laid flat on the floor 30. The two side panels 72, 74 are then lifted and connected using their main Velcro strips to the corresponding corridor Velcro strips on the walls. The top panel Velcro strip is the connected to the corresponding corridor Velcro strip on the ceiling 92. In an exemplary embodiment, corresponding Velcro strips are connected beginning at a corner first, as for example at the corner between a wall and the ceiling or a wall and the floor.

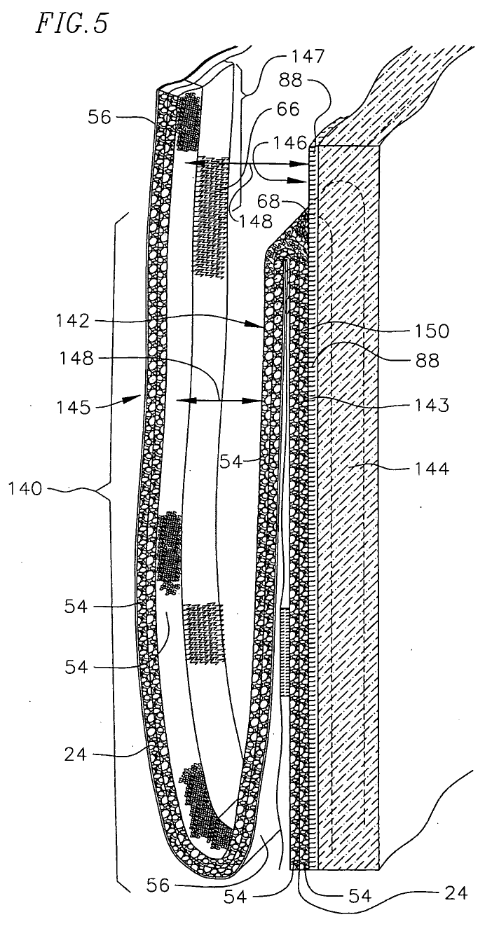

If the top and bottom panels are too wide, sections of such panels are folded upon themselves at the locations between the adjacent first and second strips 22, 24 on the top and bottom panels 76, 78, respectively such that the corresponding first strip is connected to the corresponding second strip forming a sealed fold. Similarly if the side panels are too long, their upper sections are folded upon themselves at the locations between the adjacent first and second strips 66, 68 on the side panels, respectively such that each corresponding first strip is connected to each corresponding second strip forming a sealed fold. A typical folded section 140 is formed along the side panel 24 is shown in enlarged exploded view in FIG. 5. To form the folded section 140, a first portion 142 of the panel is folded relative to the panel portion 143 connected to a wall 144 as shown in FIG. 5. A second portion 145 of the panel is folded relative to the first portion 142 of the panel. It should be noted, that the first and second folded portions of the panel are folded such that the first strip of Velcro 66 and its corresponding Velcro strip 68 are facing each other. In other words, the second folded portion is folded relative to the first folded portion at a location such that the first Velcro strip is formed on the second folded portion of the panel and the corresponding second Velcro strip is formed on the first folded portion of the panel. The second folded portion 145 of the panel is pressed along arrows 148 relative the first folded portion 142 and against the wall portion 146 such that the second folded portion of the panel connects and forms a seal with the first folded portion of the panel via the first and second Velcro strips. A seal is also formed with the wall portion 146 when a portion 147 of the main Velcro strip connected on the second folded portion extending beyond the first folded portion contacts the corridor Velcro strip 88 adhered to the wall portion 146, and connects thereto.

When a section of the top panel is folded it may drape over the opening and door panel blocking the opening through the corridor flange. In such case, the locks are moved upward along the strings pushing the upper portion of the top panel upward so as to better expose the door panel and/or opening.

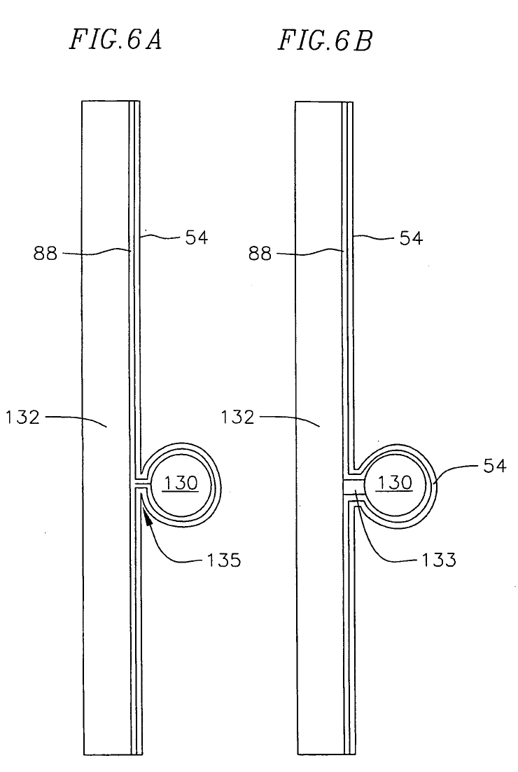

If there is hand rail 130 connected to a wall 132, as for example with a hand rail post 133, a corridor Velcro strip 88 is draped over the hand rail as for example shown in FIG. 6A at a location without the hand rail post and as shown in FIG. 6B at a location with the hand rail post. As can be seen from FIG. 6B at the location with the hand rail post, the draped Velcro strip 88 is draped and connected or adhered onto the hand rail 130 and connected or adhered onto the hand rail post. At a location without the hand rail post, the Velcro strip is draped around the hand rail 130 and connected or adhered onto the hand rail and connected or adhered onto itself at a location 135 between the wall 132 and the hand rail, as shown in FIG. 6A. The corresponding main Velcro strip is then attached to the draped corridor Velcro strip forming a sealed connection between the wall, the hand rail and the corridor flange.

In an exemplary embodiment, one of the panels may be formed with an opening 134 to accommodate a conduit, as for example a conduit coupled to a HEPA filtered air machine or vacuum source. In this regard one side of the corridor separated by the inventive corridor flange may be negatively pressurized. Furthermore, other openings may be formed to accommodate the passing of electric wires or other tubulars. These openings are each provided with a separate section that can be attached on the corridor flange so as to cover such openings when not in use.

In another exemplary embodiment, the corridor flange is designed for use in combination with an environmental containment unit such as the environmental containment unit described in U.S. Pat. No. 7,134,444 (the “'444 patent”), which is fully incorporated herein by reference. In this exemplary embodiment, a strip of material 136 is attached surrounding the opening. The strip of material defines the perimeter which is of the same size as the perimeter of the opening shown in FIG. 5A of the '444 patent and covered by panel 108. A zippered connection 138 is attached to the free edge of the strip material. In this regard, the panel 108 is removed from the environmental containment unit and the zipper 110 of the unit is then zippered onto the strip of material such that the flange is now connected to the unit. With this embodiment, the environmental containment unit provides an anteroom. The environmental unit in an exemplary embodiment is formed from the same material as the corridor flange.

In other exemplary embodiments, an environmental containment unit is connected to the corridor flange on one end and to another environmental containment unit at the other end. With this exemplary embodiment the units are formed with openings on opposite sides thereof having zippers along their edge. An opening of one unit is zippered to an opening on the other unit connecting the units. In a further exemplary embodiment, a cuff, i.e., a tunnel, is used to interconnect the units in a spaced apart relation. The cuff zippers on opposite ends to an opening of each unit. In this regard, a longer anteroom is defined to accommodate a gurney or other long objects. In an exemplary embodiment, the cuff is formed from the same material as the units. In another exemplary embodiment, the cuff may be formed from a material different from the material forming either of the units.

Although the present invention has been described and illustrated with respect to multiple embodiments thereof, it is to be understood that the present invention should not so be limited, since changes and modifications may be made therein which are within the full intended scope of this invention as hereinafter claimed. For example, the first and second Velcro strips or other first and second Velcro strips may be attached at different locations along the perimeter of the corridor flange providing more locations where the flange can be folded in order to decrease its width or its height. Furthermore, instead of the lock units other members or components may be used which allow for the pushing of the flange material upwards and for the holding of the flange material in such a location so as to not obstruct the opening 36. Furthermore, instead of applying the main Velcro strips on both side surfaces of the panels, they may be selectively applied only in the areas where there is a requirement for attachment and sealing. Moreover, the Velcro strips may be self-adhesive. In an alternate embodiment, a separate adhesive may need to be applied to connect the Velcro either to the walls or to the ceiling or floor or to the panels themselves. Furthermore, while the exemplary Velcro strips have a width of one inch, Velcro of other widths may also be used.

Although the present invention has been described and illustrated in respect to exemplary embodiments, it is to be understood that it is not to be so limited, since changes and modifications may be made therein which are within the full intended scope of this invention as hereinafter claimed. For example, instead of Velcro other types of fasteners or adhesives may be used. In one embodiment strips having tacky surfaces which are able to releasably adhere to the flange, or to a wall or to other strips which may or may not have tacky surfaces may also be used. These fasteners may be permanently or releasably attached to the surface which they will be fastening. In other embodiments a strip incorporating fasteners may be used instead of Velcro or fasteners may be directly attached to the flange. In such case, fasteners may also have to be mounted on the surfaces to which the flange has to be attached to fasten with the fasteners on the flange. These fasteners may also be on a strip which is attached to the wall or surface of the corridor. It should be noted that the term “fastener” as used herein refers to any fastener or fastening device, including among other things, Velcro, adhesives, zippers, any type of chemical fasteners, or any type mechanical fasteners such as snap buttons, buttons, button holes etc.

What is claimed is:

1. A flange for isolating a section of a corridor comprising:
a body comprising a first surface opposite a second surface;
a re-closeable opening formed through the body allowing for penetration through the flange;
a first edge;
a second edge opposite the first edge;
a third edge extending between the first and second edges;
a fourth edge opposite the third edge and extending between the first and second edges;
a first fastener adjacent the first edge;
a second fastener adjacent the second edge;
a third fastener adjacent the third edge;
a fourth fastener adjacent the fourth edge;
a first flap coupled to the flange first surface and extending over the first fastener;
a second flap coupled to the flange first surface and extending over the second fastener;
a third flap coupled to the flange first surface and extending over the third fastener; and
a fourth flap coupled to the flange first surface and extending over the fourth fastener.

2. The flange as recited in claim 1 wherein the first fastener is a first adhesive over said first surface, the second fastener is a second adhesive over said first surface, the third fastener is a third adhesive over said first surface, and the fourth fastener is a fourth adhesive over said first surface.

3. The flange as recited in claim 1 further comprising an opening through the flange for accommodating a vacuum source.

4. The flange as recited in claim 1 further comprising an opening through the flange for accommodating a conduit coupled to HEPA filtered air machine.

5. The flange as recited in claim 1 further comprising a zipper coupled to flange and surrounding at least part of the opening for coupling via zippering with an environmental containment unit.

6. The flange as recited in claim 5 wherein said zipper is for zippering said flange around an opening in the environmental containment unit.

7. The flange as recited in claim 1 further comprising means coupled to flange and surrounding at least part of the opening for coupling with an environmental containment unit.

8. The flange as recited in claim 1 comprising a section extending to the first edge, wherein said section comprises a folded portion extending from the third edge to the fourth edge.

9. The flange as recited in claim 8 further comprising means for retaining said folded portion in a location over the opening.

10. The flange as recited in claim 8 further comprising:
a string coupled to the section of the flange;
a strip attached to the flange wherein the string is sandwiched between the strip and the flange; and
a member slideable along the sting for pushing the flange along the string.

11. The flange as recited in claim 1 further comprising:
a fifth flap coupled to the flange second surface, wherein said first fastener is located between said first and fifth flaps;
a sixth flap coupled to the flange second surface, wherein said second fastener is located between said second and sixth flaps;
a seventh flap coupled to the flange second surface, wherein said third fastener is located between said third and seventh flaps; and
an eighth flap coupled to the flange second surface, wherein said fourth fastener is located between said fourth and eighth flaps.

12. The flange as recited in claim 11 wherein each fastener is an adhesive.

13. The flange as recited in claim 1 further comprising:
a fifth fastener adjacent the first fastener;
a sixth fastener adjacent the first fastener for fastening with the fifth fastener;
a seventh fastener adjacent the second fastener; and
an eighth fastener adjacent the second fastener for fastening with the seventh fastener.

14. The flange as recite in claim 13 wherein each fastener is an adhesive.

15. The flange as recited in claim 13 further comprising:
a ninth fastener adjacent the third fastener;
a tenth fastener adjacent the third fastener for fastening with the ninth fastener;
an eleventh fastener adjacent the fourth fastener; and
a twelfth fastener adjacent the fourth fastener for fastening with the eleventh fastener.

16. The flange as recited in claim 15 wherein each fastener is an adhesive.

17. The flange as recited in claim 1 wherein the first fastener is a first strip of Velcro over said first surface, the second fastener is a second strip of Velcro over said first surface, the third fastener is a third strip of Velcro over said first surface, and the fourth fastener is a fourth strip of Velcro over said first surface.

18. The flange as recited in claim 17 further comprising:
a fifth flap coupled to the flange second surface, wherein said first strip of Velcro is located between said first and fifth flaps;
a sixth flap coupled to the flange second surface, wherein said second strip of Velcro is located between said second and sixth flaps;
a seventh flap coupled to the flange second surface, wherein said third strip of Velcro is located between said third and seventh flaps; and
an eighth flap coupled to the flange second surface, wherein said fourth strip of Velcro is located between said fourth and eighth flaps.

19. The flange as recited in claim 17 further comprising:
a fifth strip of Velcro adjacent the first strip of Velcro;
a sixth strip of Velcro adjacent the first strip of Velcro for mating with the fifth strip of Velcro;
a seventh strip of Velcro adjacent the second strip of Velcro; and
an eighth strip of Velcro adjacent the second strip of Velcro for mating with the seventh strip of Velcro.

20. The flange as recited in claim 19 further comprising:
a ninth strip of Velcro adjacent the third strip of Velcro;
a tenth strip of Velcro adjacent the third strip of Velcro for mating with the ninth strip of Velcro;
an eleventh strip of Velcro adjacent the fourth strip of Velcro; and
a twelfth strip of Velcro adjacent the fourth strip of Velcro for mating with the eleventh strip of Velcro.

21. The flange as recited in claim 1 wherein the flange further comprises;
a first panel;
a second panel extending from the first panel;
a third panel extending form the first panel opposite the second panel;
a fourth panel extending from the first panel and between the second and third panels; and
a fifth panel extending from the first panel opposite the fourth panel and between the second and third panels, wherein the first fastener is mounted over the second panel, the second fastener is mounted over the third panel, the third fastener is mounted over the fourth panel, and the fourth fastener is mounted over the fifth panel.

22. The flange as recited in claim 21 wherein the opening is formed thought the first panel.

23. A flange for isolating a section of a corridor comprising:
a body comprising a first surface opposite a second surface;
a re-closeable opening formed through the body allowing for penetration through the flange;
a first edge;
a second edge opposite the first edge;
a third edge extending between the first and second edges;
a fourth edge opposite the third edge and extending between the first and second edges;
a first flap coupled to the flange first surface and extending over the first edge;
a second flap coupled to the flange first surface and extending over the second edge;
a third flap coupled to the flange first surface and extending over the third edge; and
a fourth flap coupled to the flange first surface and extending over the fourth edge.

24. The flange as recited in claim 23 further comprising:
a fifth flap coupled to the flange second surface, wherein said first edge is located between said first and fifth flaps;
a sixth flap coupled to the flange second surface, wherein said second edge is located between said second and sixth flaps;
a seventh flap coupled to the flange second surface, wherein said third edge is located between said third and seventh flaps; and
an eighth flap coupled to the flange second surface, wherein said fourth edge is located between said fourth and eighth flaps.

25. A flange for isolating a section of a corridor comprising:
a body comprising a first surface opposite a second surface;
a re-closeable opening formed through the body allowing for penetration through the flange;
a first edge;
a second edge opposite the first edge;
a third edge extending between the first and second edges;
a fourth edge opposite the third edge and extending between the first and second edges;
a fastener over said first surface adjacent one of said edges; and
a first flap coupled to the flange first surface and extending over the fastener.

26. The flange as recited in claim 25 further comprising a second flap coupled to the second surface wherein said fastener is located between said first and second flaps.

27. The flange as recited in claim 25 wherein said fastener is an adhesive.

28. The flange as recited in claim 25 wherein said fastener is a strip of Velcro.

29. A flange for isolating a section of a corridor comprising:
a body comprising a first surface opposite a second surface;
a re-closeable opening formed though the body allowing for penetration through the flange;
a perimetral edge surrounding the body;
a fastener along the perimetral edge; and
a first flap coupled to the flange first surface extending over the fastener.

30. The flange as recited in claim 29 further comprising a second flap coupled to the second surface wherein said fastener is located between said first and second flaps.

31. The flange as recited in claim 29 wherein said fastener is an adhesive.

32. The flange as recited in claim 29 wherein said fastener is a strip of Velcro extending along said perimetral edge.
